(19) United States
(12) Patent Application Publication
(10) Pub. No.: US 2016/0320851 A1
(43) Pub. Date: Nov. 3, 2016

(54) METHOD AND DEVICE FOR CONTROLLING SOUND BOX APPARATUS, AND SOUND BOX APPARATUS

(71) Applicant: LE SHI ZHI XIN ELECTRONIC TECHNOLOGY (TIANJIN) LIMITED, Beijing (CN)

(72) Inventor: Xiangjin CHEN, Beijing (CN)

(21) Appl. No.: 15/140,258

(22) Filed: Apr. 27, 2016

(30) Foreign Application Priority Data
Apr. 28, 2015 (CN) 201510212411.1

(51) Int. Cl. G06F 3/01; H04R 1/02; H04R 3/00; G06F 3/16

(52) U.S. Cl. CPC G06F 3/017; G06F 3/165; H04R 1/025; H04R 3/00

(57) ABSTRACT

The present disclosure provides a method and device for controlling a sound box apparatus and a sound box apparatus. Said method includes: emitting infrared rays at a cycle of preset time length; receiving the infrared rays reflected by a target object, and calculate the motion trajectory of the target object; judging the action of the target object according to the motion trajectory of said target object; controlling said sound box apparatus to perform corresponding control operation, according to the action of the target object. The present disclosure can realize the operation and control of the sound box apparatus through the identification of the target object, and its cost is low, and its operation is simple and not easy to be interfered by external factors.

### CROSS-REFERENCE TO RELATED APPLICATIONS

The present disclosure claims priority from Chinese Patent Application No. 2015102124111, titled “METHOD AND DEVICE FOR CONTROLLING SOUND BOX APPARATUS, AND SOUND BOX APPARATUS”, filed on Apr. 28, 2013 in the Chinese Intellectual Property Office, the contents of which in its entirety are herein incorporated by reference.

### FIELD OF TECHNOLOGY

The present disclosure relates to the technical field of a sound box apparatus, in particular to a control method and a device for a sound box, and a sound box apparatus.

### BACKGROUND

Currently, the operation of a wireless speaker device (sound box apparatus) is mainly manipulated in the form of physical buttons or touch keys. The physical buttons need to be carefully designed in the industrial practice to improve their hand feeling, which leads to a decline in the yield of good products. Because the physical buttons are usually achieved via mechanical contact, defects exist in its life of service. Touch keys are prone to misuse, and are easily affected by external factors such as there are some water droplets or a large area of iron plate.

When the physical keys and touch keys are adopted to manipulate the wireless speaker system, the user is required to directly contact with the sound box. If the user's fingers are dirty, it will cause inconvenience and affect the user's experience.

Therefore, how to use the non-contact method to control the sound box apparatus is a technical issue that needs to be solved urgently.

### SUMMARY

In view of this, the present disclosure provides a control method and a device for sound box, and the sound box apparatus, which can realize the operation and control of the sound box apparatus through the recognition of the target object. It is of low cost, convenient operation and no interference by external factors.

The present disclosure discloses method for controlling a sound box apparatus, adapted to a sound box apparatus, characterized in that, the method includes:

emitting an infrared ray at a cycle of a preset time length;

receiving the infrared ray reflected back by a target object, and calculating a motion trajectory of the target object;

judging the action of the target object according to the motion trajectory of said target object;

controlling said sound box apparatus to perform corresponding control and operation, according to the action of the target object.

In a specific embodiment of the present disclosure, receiving the infrared ray reflected back by the target object, and calculating the motion trajectory of the target object is:

adopting at least two infrared receiving sensors to receive the infrared rays which are reflected back by the target object, and calculating the motion trajectory of said target object.

In a specific embodiment of the present disclosure, adopting at least two infrared sensors to receive the infrared rays reflected back by the target object, and calculating the motion trajectory of the target object is:

adopting four receiving sensors arranged at same distance from the upper, lower, left and right positions to receive the infrared rays which are reflected back by the target object, and calculating the motion trajectory of said target object according to the sequence of receiving the infrared rays in the matrix.

In a specific embodiment of the present disclosure, controlling the sound box apparatus to perform corresponding control and operations according to the action of said target object includes:

generating an interrupt signal according to the action of the target object;

transmitting the interrupt signal to a CPU of the sound box apparatus, and controlling the sound box apparatus to perform corresponding control and operation.

In a specific embodiment of the present disclosure, transmitting the interrupt signal to the CPU of the sound box apparatus, and controlling the sound box apparatus to perform the corresponding control and operation includes:

sending the interrupt signal to the CPU of said sound box apparatus;

the CPU controlling the switching ON/OFF, adjusting volume or switching songs of said sound box apparatus, according to the interrupt signal.

Corresponding to the method, the present disclosure further discloses a device for controlling a sound box apparatus, adapted to a, characterized in that, the device includes:

an infrared emission module, configured to emit an infrared ray at a cycle of a preset time length;

an infrared receiving module, configured to receive the infrared ray reflected back by a target object, and calculating a motion trajectory of the target object;

an action judgment module, configured to judge the action of the target object according to the motion trajectory of said target object;

an operation control module, configured to control said sound box apparatus to perform corresponding control and operation, according to the action of the target object.

In a specific embodiment of the present disclosure, said infrared receiving module uses at least two infrared receiving sensors to receive the infrared rays reflected back by the target object, and calculates the motion trajectory of the target object.

In a specific embodiment of the present disclosure, said infrared receiving module is configured to adopt four receiving sensors arranged at same distance from the upper, lower, left and right positions to receive the infrared rays which are reflected back by the target object, and calculate the motion trajectory of said target object according to the sequence of receiving the infrared rays in the matrix.

In a specific embodiment of the present disclosure, the operation control module includes:

a signal generating module, configured to generate an interrupt signal according to the action of the target object;

a corresponding control module, configured to transmit the interrupt signal to a CPU of the sound box apparatus, and control the sound box apparatus to perform corresponding control and operation.

In a specific embodiment of the present disclosure, said corresponding control module includes:

a sending sub-module, configured to send the interrupt signal to the CPU of said sound box apparatus;

a control sub-module, configured to instruct the CPU of the sound box apparatus to control the switching ON/OFF, adjust volume or switch songs of said sound box apparatus, according to the interrupt signal.

The present disclosure further discloses a sound box apparatus, the sound box apparatus includes the control device above.

As per the above technical schemes, the present disclosure introduces a method of emitting infrared rays at a cycle of preset time length, and receiving the infrared rays reflected back by the target object. Thus, the motion trajectory of the target object are calculated, and the action of the target object is judged, and the corresponding control and operation of the sound box apparatus is carried out according to the action of the target object. The present disclosure realizes the operation control of the sound box apparatus through the non-contact mode, and the operation is simple and is not easy to be disturbed by the external factors. The present disclosure only needs to add the infrared emitter and infrared receivers, which are of low cost and easy to realize.

### BRIEF DESCRIPTION OF THE DRAWINGS

FIG. 1 is the schematic of the hardware structure of the sound box apparatus according to the present disclosure;

FIG. 2 is the flow chart of the control method for the sound box apparatus according to the present disclosure;

FIG. 3 is a schematic diagram of the infrared ray transmitting and receiving of the sound box apparatus according to the present disclosure;

FIG. 4 is another schematic diagram of the infrared ray transmitting and receiving of the sound box apparatus according to the present disclosure;

FIG. 5 is the flow chart of the steps S4 of the control method for the sound box apparatus according to the present disclosure;

FIG. 6 is the flow chart of the steps S42 of the control method for the sound box apparatus according to the present disclosure;

FIG. 7a-7e are the schematic diagrams of the level signal generated by the infrared gesture sensor according to the present disclosure;

FIG. 8 is the schematic of the structure of the control device of the sound box apparatus according to the present disclosure;

FIG. 9 is the schematic of the structure of the operation control module of the control device of the sound box apparatus according to the present disclosure;

FIG. 10 is the schematic of the structure of the corresponding control module of the control device of the sound box apparatus according to the present disclosure;

FIG. 11 is the schematic of the circuit connection diagram of an embodiment according to the present disclosure.

### DESCRIPTION OF THE EMBODIMENTS

The present disclosure is to transmit infrared rays at a cycle of preset time length, and to receive the infrared rays reflected back from the target object. Thus, the motion trajectory of the target object are calculated, and the action of the target object is judged, and the control operations of the sound box apparatus are carried out according to the action of the target object. The present disclosure realizes the operation control of the sound box apparatus through the non-contact mode, and the operation is simple and is not easily disturbed by the external factors. The present disclosure only needs to add the infrared emitter and infrared receivers, which are of low cost and easy to realize.

The embodiments in the present disclosure are further described in combination of the attached drawings.

One embodiment of the present disclosure provides a control method for sound box, which is applied to a sound box device. See FIG. 1, in terms of hardware, the sound box device includes the CPU11, infrared gesture sensor 12 and other hardware 13.

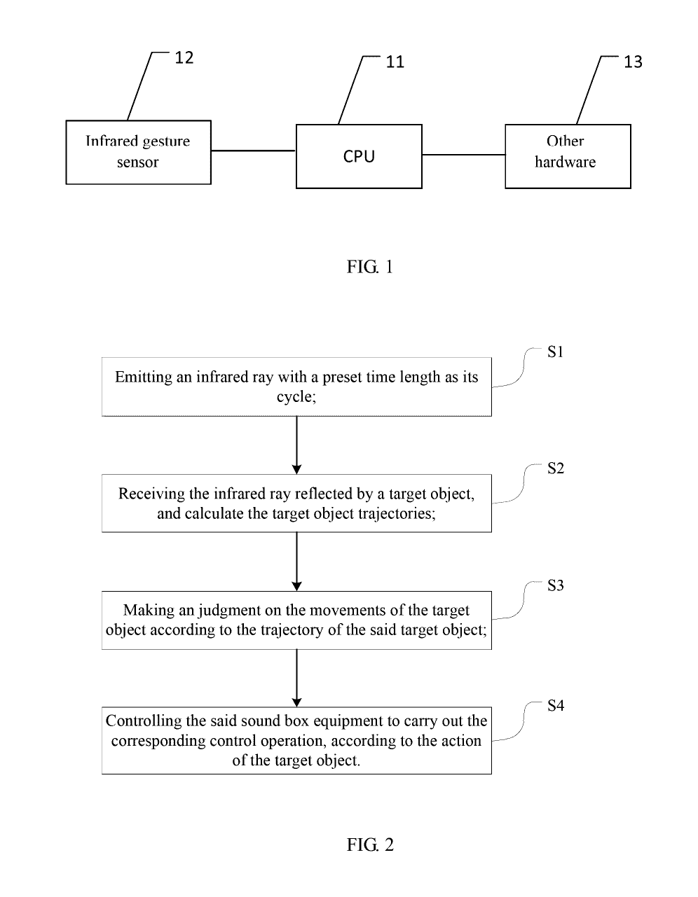

See FIG. 2, the methods in the present disclosure include:

S1, emitting infrared rays at a cycle of preset time length.

The sound box of the present disclosure is provided with an infrared gesture sensor 12 on the side facing to the user, and said infrared gesture sensor 12 can emit infrared rays at a cycle of preset time length. In particular, the preset time length is set up by the technical personnel according to the requirement, and is usually set to 2 ms.

S2, receiving the infrared rays reflected back by the target object, and calculating the motion trajectory of the target object.

The infrared rays emitted by the sound box apparatus in the present disclosure are reflected back by the target object, the reflected infrared rays are received by the infrared gesture sensor 12, and the reflected infrared rays are based on to calculate the motion trajectory of the target object.

In particular, the target object is a hand gesture, a head or other part of one's body, and even a particular operation device, such as a joystick, an induction glove, etc.

S3, the action of the target object is judged according to the motion trajectory of the target object.

In the present disclosure, the infrared gesture sensor 12 judges the action of the target object according to the motion trajectory of the target object. For example, making a judgment according to the motion trajectory of the gestures, the gestures include sliding upward, downward, leftward and rightward, and so on.

S4, controlling the sound box apparatus to perform corresponding control and operation according to the action of the target object.

Specifically, the CPU 11 of the sound box apparatus in the present disclosure receives the action of target object transmitted by the infrared gesture sensor 12, controls the sound box device to perform corresponding control and operation according to the action of the target object and the corresponding relation between the stored actions of the target object and controlling operation.

In another embodiment of the present disclosure, the method includes the steps of S1-S4, in particular, the step S2 is as below:

adopting at least two infrared receiving sensors to receive the infrared rays which are reflected back by the target object, and calculate the motion trajectory of the target object.

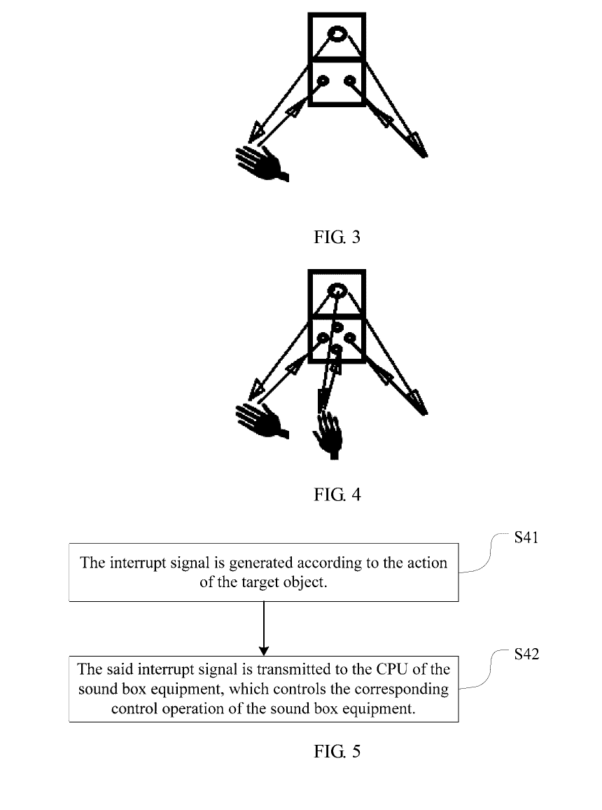

See FIG. 3, the infrared rays emitted to the target object will be reflected back, the reflected infrared rays are received by at least two infrared receiving sensors of the infrared gesture sensor 12. The present disclosure calculates the motion trajectory of the target object according to the reflected infrared rays received by at least two infrared receiving sensors. For example, calculate the motion trajectory of the target object, according to the change of the angle between the reflected infrared ray and the horizontal direction.

In the third embodiment of the present disclosure, the method includes the steps of S1-S4, in particular, the step S2 is as below:

using four infrared receiving sensors that are arranged at the same distance from each other, namely from the upward, downward, leftward and rightward directions, to receive the infrared rays reflected back by the target object, and calculate the motion trajectory of the target object according to the sequence of the infrared rays received in the matrix.

See FIG. 4, four infrared receiving sensors that are arranged at the same distance from each other, namely from the upward, downward, leftward and rightward directions, can more accurately calculate the motion trajectory of the target object sliding upward, downward, leftward and rightward, according to the infrared ray reflected back by the target object. The four infrared receiving sensors that are arranged at the same distance from each other, namely from the upward, downward, leftward and rightward directions, make the calculation more convenient, and improve the accuracy of the calculation.

The method in another embodiment of the present disclosure includes the steps of S1-S4, in particular, see FIG. 5, the step S4 includes:

S41, the interrupt signal is generated according to the action of the target object.

In the embodiment of the present disclosure, the infrared gesture sensor 12 generates a level signal as an interrupt signal according to the action of the target object, i.e., the optical signal is converted into an electric signal.

S42, the interrupt signal is sent to the CPU of the sound box apparatus, the CPU controls the sound box apparatus to perform corresponding control and operation.

The infrared gesture sensor 12 transmits the level signal to the CPU of the sound box apparatus, and the CPU controls the corresponding control and operation of sound box apparatus according to the level signal.

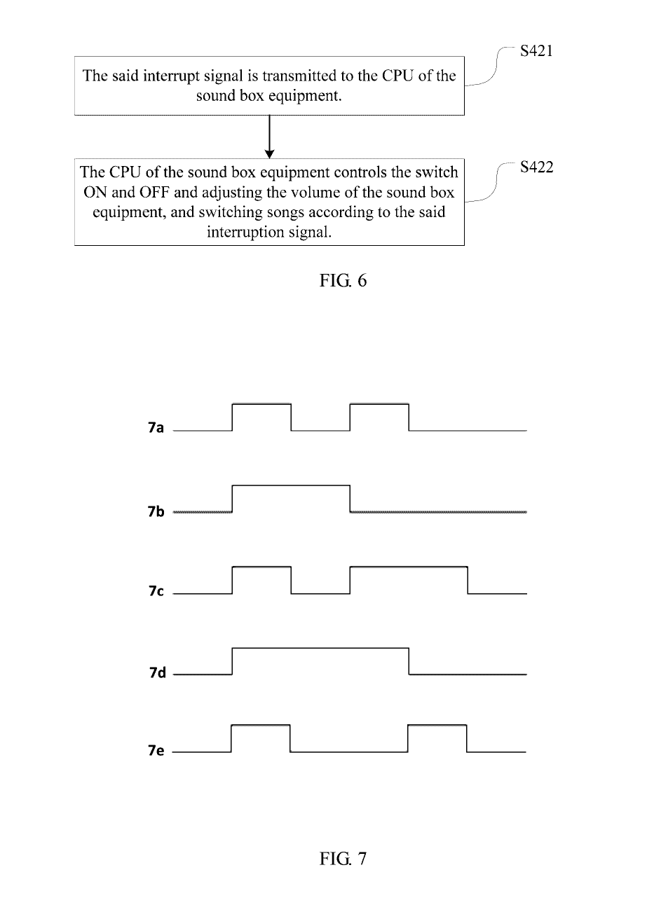

The method in another embodiment of the present disclosure includes the steps of S1-S4, in particular, see FIG. 6, the step S42 includes:

S421, the interrupt signal is transmitted to the CPU of the sound box apparatus;

S422, the CPU of the sound box apparatus controls the switching ON/OFF, adjusting the volume of the sound box apparatus and switching the songs according to the interruption signal.

In the specific implementation of the present disclosure, the infrared signal sensor 12 transmits the level signal to the CPU of the sound box apparatus. If the level signal is as shown in FIG. 7a, the CPU controls the switching ON of the sound box device; if the level signal is as shown in FIG. 7b, the CPU controls the switching OFF of the sound box device; if the level signal is as shown in FIG. 7c, the CPU maximizes the volume of the sound box device; if the level signal is as shown in FIG. 7d, the CPU minimizes the volume of the sound box device; if the level signal is as shown in FIG. 7e, the CPU controls the sound box device to play the previous song; if the level signal is as shown in FIG. 7f, the CPU controls the sound box apparatus to play the next song.

Besides the methods of the present disclosure, the present disclosure also provides a control device for a sound box apparatus, which is applied to a sound box apparatus. See FIG. 1, in terms of hardware, the sound box apparatus includes the CPU11, infrared gesture sensor 12 and other hardware 13.

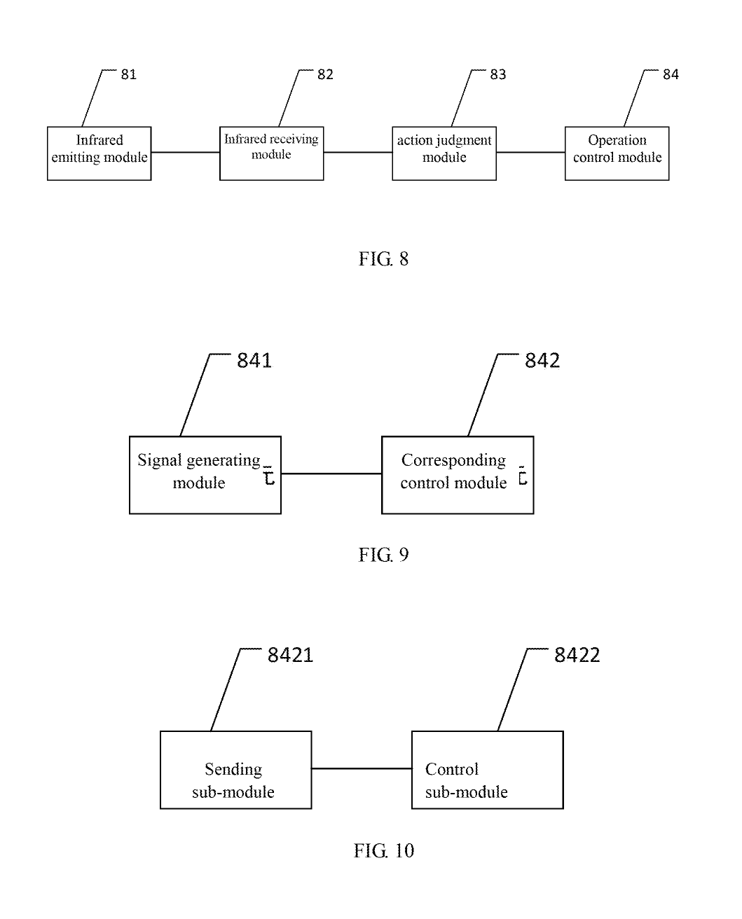

See FIG. 8, the methods in this application include:

the infrared emitting module 81, which is used for emitting infrared rays at a cycle of preset time length;

the infrared receiving module 82, which is used for receiving the infrared rays reflected back by the target object and calculating the motion trajectory of the target object;

the action judgment module 83, which is used for judging the action of the target object according to the motion trajectory of the target object;

the operation control module 84, which is used for controlling the corresponding control and operation of the sound box apparatus according to the action of the target object.

The sound box of the present disclosure is provided with an infrared gesture sensor 12 on the side facing to the user, and said infrared gesture sensor 12 can emit infrared rays at a cycle of preset time length. In particular, the preset time length is set up by the technical personnel according to the requirement, and is usually set to 2 ms.

The infrared rays emitted by the sound box apparatus in the present disclosure are reflected back by the target object, the reflected infrared rays are received by the infrared gesture sensor 12, and the reflected infrared rays are based on to calculate the motion trajectory of the target object.

In particular, the target object is a hand gesture, a head or other part of user's body, and even a particular operation device, such as a joystick, an induction glove, etc.

In the present disclosure, the infrared gesture sensor 12 judges the action of the target object according to the motion trajectory of the target object. For example, making a judgment according to the motion trajectory of the gestures, the gestures include sliding upward, downward, leftward and rightward, and so on.

Specifically, the CPU 11 of the sound box apparatus in the present disclosure receives the action of target object transmitted by the infrared gesture sensor 12, controls the sound box apparatus to perform corresponding control and operation according to the corresponding relation between the stored actions of the target object and control operation.

In another embodiment of the present disclosure, the device includes infrared emission module 81, the infrared receiving module 82, the action judgment module 83 and the operation control module 84. Specifically, the infrared receiver module 82 specifically adopts at least two infrared receiving sensors to receive the infrared rays reflected back by the target object, and calculate the motion trajectory of the target object.

See FIG. 3, the infrared rays emitted to the target object will be reflected back, the reflected infrared rays are received by at least two infrared receiving sensors of the infrared gesture sensor 12. The present disclosure calculates the motion trajectory of the target object according to the reflected infrared rays received by at least two infrared receiving sensors. For example, calculate the motion trajectory of the target object, according to the change of the angle between the reflected infrared rays and the horizontal direction.

In another embodiment of the present disclosure, the device includes infrared emission module 81, the infrared receiving module 82, the action judgment module 83 and the operation control module 84. Specifically, the infrared receiver module 82 specifically adopts four infrared receiving sensors that are arranged at same distance from upward, downward, leftward and rightward directions, to receive the infrared rays reflected back by the target object, and calculate the motion trajectory of the target object as per the sequence of receiving the infrared rays.

See FIG. 4, four infrared receiving sensors that are arranged at the same distance from each other, namely from the upward, downward, leftward and rightward directions, can more accurately calculate the motion trajectory of the target object sliding upward, downward, leftward and rightward, according to the infrared ray reflected back by the target object. The four infrared receiving sensors that are arranged at the same distance from each other, namely from the upward, downward, leftward and rightward directions, make the calculation more convenient, and improve the accuracy of the calculation.

In the other embodiment of the present disclosure, the device includes the infrared emitting module 81, the infrared receiving module 82, action judgment module 83 and the operation control module 84. Specifically, see FIG. 9, the operation control module 84 includes:

the signal generating module 841, which is used for generating an interrupt signal according to the action of the target object;

in the embodiment of the present disclosure, the infrared gesture sensor 12 generates a level signal as an interrupt signal according to the action of the target object, i.e., the optical signal is converted into an electric signal;

the corresponding control module 842 is used for transmitting the interrupt signal to the CPU of the sound box apparatus, which controls the corresponding control operation of the sound box apparatus;

the infrared gesture sensor 12, which transmits the level signal to the CPU of the sound box apparatus, and the CPU controls the corresponding control and operation of the sound box apparatus according to the level signal.

In another embodiment of the present disclosure, the device includes the infrared emission module 81, the infrared receiver module 82, the action judgment module 83, and the operation control module 84. Specifically, see FIG. 10, the corresponding control module 842 includes:

the sending sub-module 8421 is used for transmitting the interrupt signal to the CPU of the sound box apparatus.

the control sub-module 8422 is used to control the switching ON/OFF, adjusting the volume of the sound box apparatus and switching the song via the CPU of the sound box apparatus according to the interruption signal.

In the specific implementation of the application, the infrared signal sensor 12 transmits the level signal to the CPU of the sound box apparatus. If the level signal is as shown in FIG. 7a, the CPU controls the switching ON of the sound box apparatus; if the level signal is as shown in FIG. 7b, the CPU controls the switching OFF of the sound box apparatus; if the level signal is as shown in FIG. 7c, the CPU maximizes the volume of the sound box apparatus; if the level signal is as shown in FIG. 7d, the CPU minimizes the volume of the sound box apparatus; if the level signal is as shown in FIG. 7e, the CPU controls the sound box apparatus to play the previous song; if the level signal is as shown in FIG. 7f, the CPU controls the sound box apparatus to play the next song.

Besides the methods and devices of the present disclosure, the present disclosure also provides a sound box apparatus, including the control devices discussed in the above scheme.

Below, a concrete embodiment is adopted to further illustrate the implementation of this application.

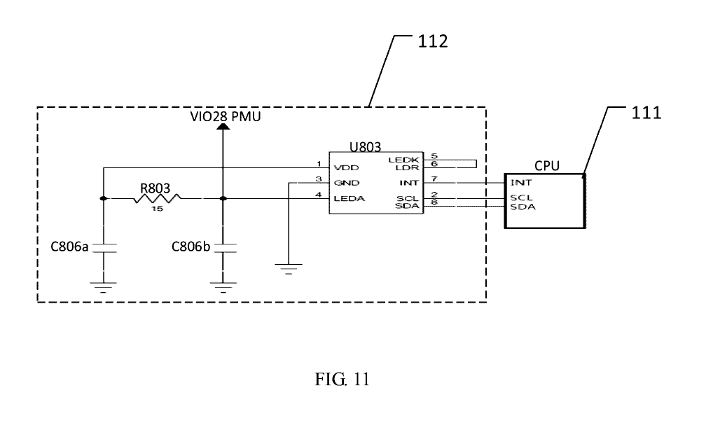

See FIG. 11, the sound box apparatus includes CPU111 and gesture sensors 112.

The gesture sensor 112 includes: a chip U803 and a resistor R803, a capacitor C806a and a capacitor C806b. One end of the capacitor C806a is connected to the first pin VDD of the chip U803, and is connected to fourth pin LEDA of the chip U803 via one end of the resistor R803, the other end is connected to the ground. One end of the capacitor C806b is connected to the fourth pin LEDA of the chip U803, and another end of the resistor R803 and signal VIO28PMU (reflected infrared rays), the other end is connected to the ground. The third pin GND of the chip U803 is connected to the ground, its fifth pin LEDK is connected to its sixth pin LDR. Its seventh pin INT is connected to the seventh pin INT of the CPU111, its second pin SCL is connected to the SCL of CPU111, its eighth pin is connected to SDA of CPU111. The chip U803 integrates with an infrared emitter, four infrared receivers that are arranged at same distance from upward, downward, leftward and rightward directions, and software algorithm to achieve the functions such as the infrared emitting module and infrared receiving module, action-judgment module etc.

The infrared transmitter of the gesture sensor 112 emits infrared rays at a cycle of preset time length, and the four infrared receivers receive the infrared ray that is reflected back by the target object and calculate the motion trajectory of the target object. The gesture sensor 112 judges the action of the target object according to the motion trajectory of the target object. The gesture sensor 112 generates and transmits an interrupt signal (level signal) to the CPU111 according to the action of the target object. The CPU111 controls the sound box apparatus to carry out corresponding control and operation according to the interruption signal.

The above is only a better embodiment of the application and not to limit this application, any changes made, or equivalent replacement and improvement where within the spirit and principle of the application, shall be included within the protection scope of the application.

1. A method for controlling a sound box apparatus, adapted to a sound box apparatus, characterized in that, the method comprises:
emitting an infrared ray at a cycle of a preset time length;
receiving the infrared ray reflected back by a target object, and calculating a motion trajectory of the target object;
judging the action of the target object according to the motion trajectory of said target object;
controlling said sound box apparatus to perform corresponding control and operation, according to the action of the target object.

2. The method of claim 1, characterized in that, receiving the infrared ray reflected back by the target object, and calculating the motion trajectory of the target object is:
adopting at least two infrared receiving sensors to receive the infrared rays which are reflected back by the target object, and calculating the motion trajectory of said target object.

3. The method of claim 2, characterized in that, adopting at least two infrared sensors to receive the infrared rays reflected back by the target object, and calculating the motion trajectory of the target object is:
adopting four receiving sensors arranged at same distance from the upper, lower, left and right positions to receive the infrared rays which are reflected back by the target object, and calculating the motion trajectory of said target object according to the sequence of receiving the infrared rays in the matrix.

4. The method of claim 3, characterized in that, controlling the sound box apparatus to perform corresponding control and operations according to the action of said target object comprises:
generating an interrupt signal according to the action of the target object;
transmitting the interrupt signal to a CPU of the sound box apparatus, and controlling the sound box apparatus to perform corresponding control and operation.

5. The method of claim 3, characterized in that, transmitting the interrupt signal to the CPU of the sound box apparatus, and controlling the sound box apparatus to perform the corresponding control and operation comprises:
sending the interrupt signal to the CPU of said sound box apparatus;
the CPU controlling the switching ON/OFF, adjusting volume or switching songs of said sound box apparatus, according to the interrupt signal.

6. A device for controlling a sound box apparatus, adapted to a sound box apparatus, characterized in that, the device comprises:
an infrared emission module, configured to emit an infrared ray at a cycle of a preset time length;
an infrared receiving module, configured to receive the infrared ray reflected back by a target object, and calculating a motion trajectory of the target object;
an action judgment module, configured to judge the action of the target object according to the motion trajectory of said target object;
an operation control module, configured to control said sound box apparatus to perform corresponding control and operation, according to the action of the target object.

7. The device of claim 6, characterized in that, said infrared receiving module uses at least two infrared receiving sensors to receive the infrared rays reflected back by the target object, and calculates the motion trajectory of the target object.

8. The device of claim 7, characterized in that, said infrared receiving module is configured to adopt four receiving sensors arranged at same distance from the upper, lower, left and right positions to receive the infrared rays which are reflected back by the target object, and calculate the motion trajectory of said target object according to the sequence of receiving the infrared rays in the matrix.

9. The device of claim 8, characterized in that, the operation control module comprises:
a signal generating module, configured to generate an interrupt signal according to the action of the target object;
a corresponding control module, configured to transmit the interrupt signal to a CPU of the sound box apparatus, and control the sound box apparatus to perform corresponding control and operation.

10. The device of claim 8, characterized in that, said corresponding control module comprises:
a sending sub-module, configured to send the interrupt signal to the CPU of said sound box apparatus;
a control sub-module, configured to instruct the CPU of the sound box apparatus to control the switching ON/OFF, adjust volume or switch songs of said sound box apparatus, according to the interrupt signal.

11. A sound box apparatus, characterized in that the sound box apparatus comprises the device according to claim 6.

12. The method of claim 4, characterized in that, transmitting the interrupt signal to the CPU of the sound box apparatus, and controlling the sound box apparatus to perform the corresponding control and operation comprises:
sending the interrupt signal to the CPU of said sound box apparatus;
the CPU controlling the switching ON/OFF, adjusting volume or switching songs of said sound box apparatus, according to the interrupt signal.

13. The device of claim 9, characterized in that, said corresponding control module comprises:
a sending sub-module, configured to send the interrupt signal to the CPU of said sound box apparatus;
a control sub-module, configured to instruct the CPU of the sound box apparatus to control the switching ON/OFF, adjust volume or switch songs of said sound box apparatus, according to the interrupt signal.
